(19) United States
(12) Patent Application Publication
(10) Pub. No.: US 2006/0200792 A1
(43) Pub. Date: Sep. 7, 2006

(54) Process templates for software creation

(75) Inventors: Amy R. Hagstrom, Duvall, WA (US); Anuj Bansal, Sammamish, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/073,981

(22) Filed: Mar. 7, 2005

(51) Int. Cl. G06F 9/44

(52) U.S. Cl. 717/101

(57) ABSTRACT

A method and apparatus for generating a process template useable for implementing a software creation process. Process templates may include tools, content, work items, workflow, process guidance, group and permission information, a project structure, a project roadmap, and/or check-in policies to be used in the software creation process. Information included in the process templates may be fully customizable as needed for different software creation projects. Process templates may be modified before and during implementation during the software creation process to incorporate new tools, content, work items, etc. as desired.

### BACKGROUND OF INVENTION

1. Field of Invention

This invention relates to process templates for use in a software creation process.

2. Related Art

Software creation typically involves the work of one or more people to design an overall structure or framework for the software product, as well as other aspects of the software product, such as performance, serviceability, maintainability, or other requirements that need to be met. The process also typically involves the work of one or more programmers or other individuals that assemble and/or create various portions of the source code, frequently using various tools and available content to create respective portions of the software product. Other individuals may test the software during/after the creation process to detect bugs or aspects of the software that do not operate in a desired way. Identification of such problems may lead to further work, for example, by the programmers to correct the identified bugs or other problems. Thus, in some software creation processes, a series of iterative steps may be taken to create one or portions of a software product, test those portions for desired operability characteristics, followed by repair and/or modification of the software product.

As a result, a software creation process typically involves numerous people performing different tasks, using different tool sets and/or content, working on different project sections and on different timelines. Proper management of the work of these individuals, the tools and/or content they use or other aspects of the software creation process may be desired to efficiently use resources to complete the project and achieve desirable, consistent results in the software being created.

### SUMMARY OF INVENTION

In some cases, use of a process template, i.e., a kind of guide to the appropriate use of tools, processes, content or other items in a software creation process, can be useful when managing and/or implementing the process. The inventors have appreciated that the creation of a process template for use in tracking and guiding the progress of a software creation process may improve efficiency and/or provide other benefits. For example, in one aspect of the invention, a process template may be created to detail various aspects of a software creation project, such as the tools and/or content, processes, work item lists and workflow, reports to be generated, check-in policies or notes, a project roadmap or project structure, and/or groups of users and each group's permission to perform various tasks, to be used as part of the software creation process. The process template (e.g., in the form of a XML file) may be used by individuals involved in the software creation process (e.g., via a web portal) so they can determine the work items and work flow information, processes, tools and/or content, report types and/or formats, check-in policies, process guidance, and other information needed for their activities. The application of a process template against a software creation process allows individuals involved in the software creation to receive direction from a common source so that all members of the team can work in concert. The process template may also be used to track the progress of the software creation process, e.g., by directing a tool used by the process template to store information that particular work items are complete or otherwise indicating work item completion status, to provide reports as to the project's status, etc.

Aspect of the invention provide a customizable and fully extensible mechanism by which workgroups can create process templates for software creation processes. That is, each software creation process may require different tools, processes, content, reports, etc. and the process template for each software creation process can incorporate the specific, unique requirements necessary. For example, if a particular software project requires a certain tool, the identity, locations and other specifics for the use of that tool in the process may be defined in the process template. Another software project may require particular content that has not been used in any other prior project. In this case, the new content may be suitably incorporated into the process template so that it is appropriately used when creating the software product.

In addition to allowing customization of process templates for individual projects, aspects of the invention also allow for more uniform application of certain tools, content, policies or other features in several different software creation processes. For example, an organization may require that all software creation processes use particular tools, content, policies, create specific reports at specific project milestones, etc. These common requirements may be implemented in all process templates used in all of the software creation processes engaged in by the organization, and thus help insure that the software creation processes all include the use of desired tools, content, reports, etc.

In one aspect of the invention, a computer-readable storage device is provided with information for use in a software creation process. The information may include a process template usable by individuals (e.g., through one or more applications) for instruction in engaging in the software creation process, where the process template includes at least information regarding tools to be used in creating the software, information regarding use of the tools, and information regarding processes to be followed in creating the software.

In another aspect of the invention, a method for generating a process template for use in creating software is provided. Information regarding a process template to be used by individuals engaging in a software creation process is provided, where the information includes at least information regarding tools to be used in creating the software, information regarding use of the tools, and information regarding processes to be followed in creating the software. The information representing the process template is stored in a computer-readable device, e.g., for subsequent use by individuals when performing the software creation process.

In another aspect of the invention, a method for creating software includes providing information from a computer-readable device regarding a process template to be used by individuals engaging in a software creation process. The information may include at least information regarding tools to be used in creating the software, information regarding use of the tools, and information regarding processes to be followed in creating the software. At least one of the tools may be used in the software creation process based on the information regarding use of the tool in the process template.

### BRIEF DESCRIPTION OF THE DRAWINGS

Aspects of the invention are described below with reference to the drawings in which like numeral reference like elements, and wherein:

FIG. 1 is a schematic representation of a process template and various items that may be included in a process template in accordance with the invention.

FIG. 2 is a schematic representation of an apparatus configured to generate process templates in accordance with the invention.

### DETAILED DESCRIPTION

Aspects of the invention are described below with reference to illustrative embodiments. It should be understood that reference to these illustrative embodiments is not made to limit aspects of the invention in any way. Instead illustrative embodiments are used to aid in the description and understanding of various aspects of the invention. Therefore, the following description is intended to be illustrative, not limiting.

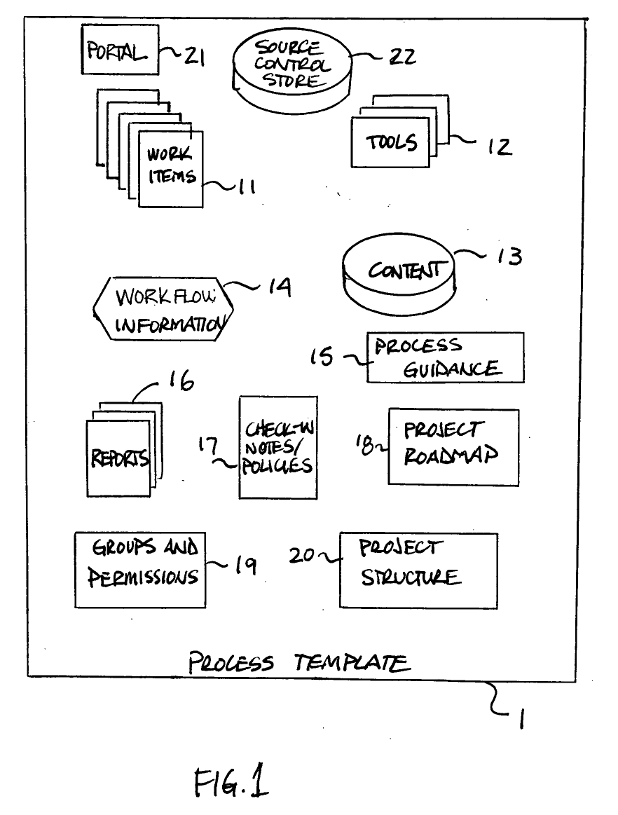

As discussed above, in one aspect of the invention, a process template may be used in implementing a software creation process. A process template created in accordance with aspects of the invention may include any suitable information. In one illustrative embodiment, FIG. 1 shows a process template 1 having several different components. In this embodiment, the process template 1 is in the form of an XML file, but may be arranged in any suitable way. The process template 1 and its corresponding information may be stored in a computer-readable device, such as a volatile or non-volatile semiconductor or other memory, an optical or magnetic storage medium, etc., so that the process template 1 may be accessed via computer by individuals involved in the software creation process. The components included in the process template 1 may be in any suitable form or format, and may vary widely from each other. For example, some components may include graphic or other image files, text, a representation of a project hierarchy, pre-defined report formats, pre-defined queries, executable files or other computer code, addresses, file names or other identifiers of information, and so on. Thus, the process template 1 may serve as a connection, or otherwise define a relationship, between the different components in the template so as to provide the overall desired guidance for the software creation process. Applications used by various individuals may interact with the process template 1 and perform various functions in accordance with requirements or other information included in the process template 1.

In this illustrative embodiment, the process template 1 includes one or more work items 11. Although the work items 11 may take any suitable form, in this embodiment, the work items 11 are each a database record that indicates a particular task to be completed in the software creation process. The work item 11 (e.g., database record) may also include other information, such as a person or group designated to process the task, identify a tool, content or other resource for processing the task, identify one or more dependencies for the task (such as other tasks that should be completed before the instant task is processed), an indication of the task's completion status, comments entered by individuals that processed or are processing the task, and so. As might be expected in a software creation process, many different work items 11 may be required.

Each of the work items 11 may be individually established or otherwise created by a user when generating the process template 1. Alternately, the process template wizard or other mechanism may draw from previously established work items 11, e.g., such as those work items used in other process templates for similar software creation processes. Also, the process template wizard may automatically generate work items 11 in response to certain input provided from a user. For example, when creating the process template, the wizard may receive information from the user that a particular task or set of tasks is to be performed. In response, the wizard may automatically generate work items 11 that are associated with the identified set of tasks, e.g., the wizard may “know” that a certain task identified by the user requires a related set of tasks to be performed and insert the related set of tasks into the process template. Work items 11 may be stored in a list, a database, e.g., a relational, flat file or other suitable form of database, or in any other way.

The process template 1 in this example also includes one or more tools 12. The tools 12 may actually be stored, e.g., in executable form, as part of the process template 1, or may simply be identified in the process template 1 as a tool related to the software creation process. The tools may be referenced in work items 11 or in other ways in a process template 1. Similarly, content 13 for use in the software creation process may be stored as part of the process template 1 or referenced by other components in the template 1. Such content 13 may include any suitable information, such as text, document templates, graphics or other image files, web pages, or other.

The process template 1 may also include workflow information 14 that specifies the order in which work items 11 are to be processed and/or indicates dependency information for work items 11 or tools 12. Dependency information may indicate certain requirements for processing a work item 11 or using a tool 12. For example, a particular work item 111 may not be able to be processed until other specified work items 11 are completed. Thus, the processing of a work item 11 may be made dependent on the completion of other work items 11. Alternately, the use of a particular tool 12 may only be permitted if a specific work item 11 or other tool 12 has been implemented. Work flow information 14 may be stored and/or used in any suitable way, such as included work item 11 records, in the form a Gantt chart, or other process flow diagram.

The process template 1 may also include process guidance 15 that can be used by individuals involved in the software creation process as a “help” tool. For example, an individual assigned to completing a work item 11 may be uncertain as to how the task is expected to be completed. In this case, process guidance information 15 may be provided that the individual can access to understand the meaning of various entries in the process template 1, the meaning of certain words or terms, and so on. Alternately, or in addition, the process guidance information may include information regarding the processes to be performed or followed during the software creation. For example, the process guidance information may detail certain requirements be met during the software creation, followed by certain approvals, etc.

The process template may also include reports 16 and/or queries for use in implementing the process template 1. For example, software creation process administrators may want to periodically determine the project's status, and may request and obtain one or more reports 16. In one embodiment, an administrator may want to know how many work items 11 have been opened, how many have closed, and how many are currently being processed. The process template 1 may include a pre-defined report 16 that queries a work item 11 database or other suitable information source for the information and then compiles the suitable information into the report. Queries that are used to obtain information from one or more sources may be built into the reports 16 so that the queries need not be generated each time a report is requested. It will be understood that any suitable report including any suitable information may be included in the process template 1. Also, information included in the report may be obtained from sources other than the process template, if desired.

A process template may also include check-in notes and/or policies 17 that define how certain individuals involved in the software creation process must perform check-in procedures and/or annotate their check-in procedures. The process template 1 may also include a project roadmap 18 and/or a project structure 20. The project roadmap 18 may provide an overview of the various tasks and other processes to be performed or followed as well as indicating desired milestones or other important events. The project structure 20 may indicate such information as the identity of various individuals that are responsible for different portions of the software creation process along with their position in an organizational hierarchy, if any. The project structure 20 may also provide an indication of the software product's components and/or groupings.

The process template 1 may also include group and permission information 19 regarding various groups of users involved in the software creation project as well as permissions for the members of the groups to perform certain actions. For example, one group of users may be entitled to run certain reports 16 in the process template 1 and view the results. Users outside of the group, or otherwise not associated with it, may be denied access to such information. As another example, users in certain groups may be granted permission to use certain tools and/or access certain content to enable them to perform assigned work items. Users not needing to use such tools or access such content may be denied permission to them, insuring that those users use other more appropriate tools and/or content or other resources. Thus, the process template may include information regarding different user groups (and their members) as well as the various permissions that the different groups have in relation to the software creation process.

The process template 1 may also include a portal 21, such as a web site, to allow one or more users to access the process template 1, e.g., via one or more applications operating on the user's computer. A source control store 22 may also be provided in the process template 1 for storing, and controlling access to, source code for the software being created.

Once a process template 1 has been generated using the wizard, it may be provided for use by one or more members of a group involved in the corresponding software creation process. These users may refer to the process template 1, e.g., via the portal 21 or other application determined by the process template, to identify work items 11 that they are assigned to, to update work item status, identify certain tools or content that should be used in a particular software creation process, review reports regarding the process status or other process information, and so on. Such a template may be invaluable, since all members involved in the software creation process may be assured that they are working from the same, common set of tasks, tools, content, instructions or other information used to guide the software creation process.

It should also be appreciated that process templates for different software creation processes may include different tools, content, workflow information, or other resources so that process templates can be customized for each individual software creation project. This can allow a process template to be a very powerful tool since it allows for customization as needed. In addition, this arrangement may allow all of the process templates for different software projects to include certain desired components. For example, an organization may wish to require that certain reports be generated on a periodic basis for all software projects. This requirement may be built into the process template generation so that the report format is provided in each process template and so that workflow or other information is properly provided so that the reports are generated on a desired schedule. In another example, an organization may require that only certain tools or certain content be used in certain software projects. This requirement may be made, for example, so that licensed content is incorporated into the software creation process. Thus, the required content, tools or other information may be incorporated into the process template for all software projects.

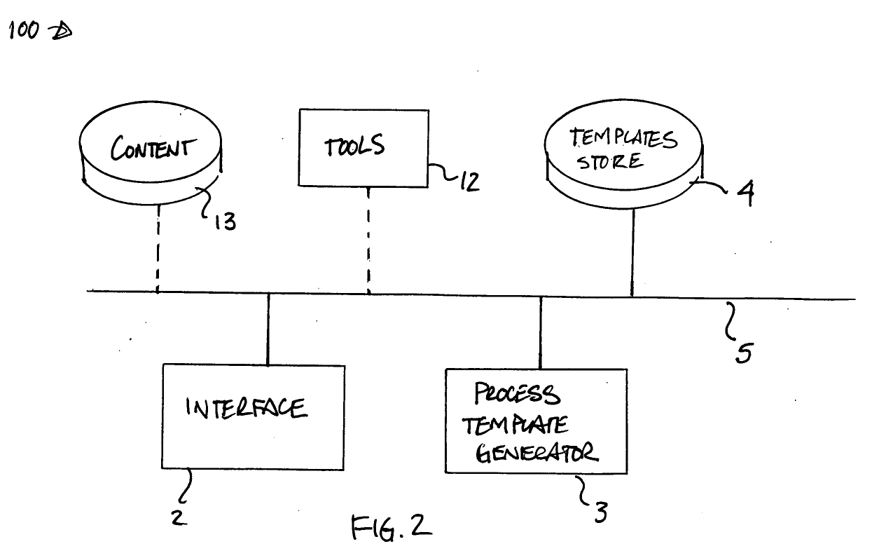

FIG. 2 shows a schematic view of an apparatus 100 arranged for the generation of one or more process templates in accordance with aspects of the invention. In this embodiment, the apparatus 100 includes an interface 2 by which the apparatus 100 may receive and/or output information. In one embodiment, the interface 2 may include a visible display, keyboard, touch screen, mouse or other pointing device, printer, a graphical user interface, and/or other devices by which information may be provided both to and from a user. The interface 2 may also include other devices, such a graphical user interface, devices to send/receive information to/from other electronic devices, or other. The apparatus 100 may also include a process template generator 3 that uses information provided via the interface 2 or otherwise to create a process template that is stored in a template store 4. Various portions of the apparatus 100 may communicate via a communications system 5 that may include any suitable device or combination of devices, such as a bus, wired or wireless LAN or other computer network, the Internet, and so on. The interface 2 and/or process template generator 3 may be implemented, at least in part, as one or more software modules operating on a general purpose computer or network of computers. The templates store 4 may include any suitable storage device, such as magnetic or optical storage devices, volatile or nonvolatile memory, etc.

A user may begin the generation of a process template by providing a suitable indication to the process template generator 3 via the interface 2. Thereafter, the process template generator 3 may query the user for various information, such as work items, tools, processes, content, workflow information for the software creation process. The process template generator 3 may also request other information, such as desired reports, check-in notes and/or policies, may allow the user to define a project roadmap or project structure, etc. The process template generator 3 may refer to other stored process templates for some information, such as pre-defined queries, reports, work items, workflow information, and so on. The process template generator 3 may access tools 12 and/or content 13 that are optionally electronically linked with the apparatus 100. Thus, the process template generator 3 may incorporate any desired tools and/or content into the process template 1 from any suitable source. Other resources may also be accessed by the process template generator 3, such as report formats, group and permission information.

The process template generator 3 may also allow user groups and their respective permissions to be defined, and may also provide process guidance either during the process template generation and/or after the process template is complete. That is, the process template generator 3 may provide help to the user when creating the process template, e.g., answering questions as to how to input information, or what certain terms used in the template mean. In addition, process guidance may be provided within the process template 1 so that the guidance can be accessed later when the software project has begun. The completed process template may be stored in a template store 4 so that it may be accessed by users in implementing the software creation process.

Process templates in accordance with aspects of the invention may be revised based on new or changed information to create a revised process template that incorporates the new or changed information. For example, after a software creation process has been started, software designers may determine that a different tool or content should be used in the software creation process. Thus, one may go back and revise the existing process template so that it includes the new tool, content or other requirement. The process template may also be revised to create new work items or other components to ensure that the new tool or content use, etc. gets implemented.

The process templates may also include one or more sets of instructions that are exportable from the process template to a tool for implementation by the tool. For example, when generating the process template, a use may include one or more sets of instructions that are to be implemented by a tool during the software creation process. Thus, when implementing the software creation process, an individual may identify the instruction set in the process template and appropriately have the tool implement the instructions as indicated in the process template. Export of the instruction set(s) may also be automated, e.g., so a user can simply instruct the process template to export the instructions to a tool, which implements them upon receipt or other suitable command.

While the invention has been described in conjunction with specific embodiments thereof, it is evident that many alternatives, modifications, and variations will be apparent to those skilled in the art. Accordingly, embodiments of the invention as set forth herein are intended to be illustrative, not limiting. Various changes may be made without departing from the spirit and scope of the invention.

1. A computer-readable storage device including information for use in a software creation process, the information comprising:
a process template usable by individuals for instruction in engaging in the software creation process, where the process template includes at least information regarding tools to be used in creating the software, information regarding use of the tools, and information regarding processes to be followed in creating the software.

2. The device of claim 1, wherein the process template further comprises information regarding content to be used, work items to be completed and/or workflow to be followed in the software creation process.

3. The device of claim 3, wherein the process template includes a plurality of work items and a sequence in which certain of the plurality of work items are to be performed.

4. The device of claim 1, wherein the process template includes group and permission information, a project structure, a project roadmap, and/or check-in policies to be used in the software creation process.

5. The device of claim 1, wherein the process template includes a source control store for storing source code created in the software creation process.

6. The device of claim 1, wherein the process template includes at least one report to be generated as part of the software creation process.

7. The device of claim 1, wherein the process template is adapted to be revised based on new or changed information regarding the software creation process.

8. The device of claim 7, wherein the new or changed information includes a custom tool or custom content to be used in the software creation process.

9. The device of claim 1, wherein the process template includes at least one set of instructions that are exportable from the process template to a tool for implementation by the tool.

10. A method for generating a process template for use in creating software, comprising:
providing information regarding a process template to be used by individuals engaging in a software creation process, where the information includes at least information regarding tools to be used in creating the software, information regarding use of the tools, and information regarding processes to be followed in creating the software; and
storing information representing the process template in a computer-readable device.

11. The method of claim 10, wherein the process template includes information regarding a plurality of work items and defines a sequence in which certain of the plurality of work items must be performed.

12. The method of claim 10, wherein the process template includes information regarding group and permission information, a project structure, a project roadmap, and/or check-in policies to be used in the software creation process.

13. The method of claim 10, wherein the process template includes information regarding content to be used, work items to be completed and/or workflow to be followed in the software creation process.

14. The method of claim 10, wherein the process template is accessed by individuals via one or more applications used by the individuals in the software creation process.

15. The method of claim 10, further comprising:
providing new or changed information for the software creation process; and
creating a revised process template that incorporates the new or changed information.

16. The method of claim 15, wherein the step of creating a revised process template is performed after the software creation process has been started.

17. The method of claim 15, wherein the new or changed information includes a custom tool or custom content to be used in the software creation process.

18. The method of claim 10, wherein the process template includes at least one set of instructions that are exportable from the process template to a tool for implementation by the tool.

19. The method of claim 10, further comprising:
implementing the process template to create the software.

20. A method for creating software, comprising:
providing information from a computer-readable device regarding a process template to be used by individuals engaging in a software creation process, where the information includes at least information regarding tools to be used in creating the software, information regarding use of the tools, and information regarding processes to be followed in creating the software; and
using at least one of the tools based on the information regarding use of the tool in the process template.
